(19) United States
(12) Patent Application Publication
(10) Pub. No.: US 2018/0050445 A1
(43) Pub. Date: Feb. 22, 2018

(54) Striker for a Nail Gun

(71) Applicant: Basso Industry Corp, Taichung (TW)

(72) Inventors: Chien-Kuo Po, Taichung (TW); Ching-Han Chang, Taichung (TW)

(21) Appl. No.: 15/677,438

(22) Filed: Aug. 15, 2017

(30) Foreign Application Priority Data
Aug. 19, 2016 (TW) 105126503

(51) Int. Cl. B25C 1/04; B25C 1/18

(52) U.S. Cl. CPC B25C 1/047; B25C 1/188

(57) ABSTRACT

A striker includes a base portion, a striking portion, and two reinforcing ribs. The base portion has opposite slide surface and base surface, and a front end surface connected between the slide and base surfaces. The striking portion is formed on the front end surface, and has a maximum width in a direction perpendicular to a longitudinal axis smaller than a width of the front end surface. The reinforcing ribs are connected to the base portion. Each reinforcing rib has first and second edges disposed respectively distal from and proximate to the base surface in a direction perpendicular to the longitudinal axis, and disposed respectively distal from and proximate to the striking portion in a direction parallel to the longitudinal axis.

### CROSS-REFERENCE TO RELATED APPLICATION

This application claims priority of Taiwanese Patent Application No. 105126503, filed on Aug. 19, 2016.

### FIELD

The disclosure relates to a striker, and more particularly to a striker for a nail gun that is adapted for striking a nail.

### BACKGROUND

Referring to FIG. 1, a conventional striker 1 of a nail gun includes a base portion 12, a striking portion 11 formed on a front end of the base portion 12 for striking a nail (not shown), a middle rib 13 formed on a top surface of the base portion 12, and opposite side ribs 14 connected respectively to opposite sides of the base portion 12.

Since a significant impact may occur during each nail-striking operation, the striker 1 is required to have sufficient structural strength to withstand such impact, and the cross-section of the striking portion 11 has to be relatively small so as not to strike more than one nail in each nail-striking operation.

However, with a drop of height (A) being formed between each of the side ribs 14 and the base portion 12, stress will mostly concentrate at areas around the drop of height (A), which may easily cause fracture of the striker 1.

Referring to FIG. 2, Japanese Patent Application Publication No. 2010-69563 discloses another conventional striker 2 including opposite side ribs. Each of the side ribs has a stepped configuration that has multiple drops of height (B) with respect to the base portion of the conventional striker 2 for reducing the concentration of stress.

However, since the size of the side ribs are limited in order to form the stepped configuration, the structural strength of the conventional striker 2 may still be insufficient.

Referring to FIG. 3, U.S. Pat. No. 7,021,516 discloses another conventional striker 3 including a base portion 32 having a bottom surface that is slidable along a channel, a striking portion 31 formed on a front end of the base portion 32, and a reinforcing rib 33 formed on the bottom surface and having a front section that has an inclined surface 331. Due to the configuration of the inclined surface 331, nails having relatively small nail heads (e.g., the cross-section thereof is less than 0.6 square millimeter) may not be stricken by the striking portion 31, and may eventually be stuck in the channel under the reinforcing rib 33.

### SUMMARY

Therefore, an object of the disclosure is to provide a striker that can alleviate at least one of the drawbacks associated with the abovementioned prior arts.

Accordingly, the striker is adapted to be slidable along a channel of a nail gun for striking a nail head of a nail. The striker includes a base portion, a striking portion and two reinforcing ribs. The base portion has a slide surface adapted to be slidable along the channel, a base surface opposite to the sliding surface and extending along a longitudinal axis, and a front end surface connected between the slide surface and the base surface. The striking portion is formed on the front end surface of the base portion, is adapted for striking the nail head of the nail, and has a maximum width perpendicular to the longitudinal axis that is smaller than a width of the front end surface of the base portion. The reinforcing ribs are disposed respectively at opposite sides of the longitudinal axis, are connected to the base portion, and extend along the longitudinal axis. Each of the reinforcing ribs has an extension portion having first and second edges. The first and second edges are disposed respectively distal from and proximate to the base surface in a direction perpendicular to the longitudinal axis, and are disposed respectively distal from and proximate to the striking portion in a direction parallel to the longitudinal axis.

### BRIEF DESCRIPTION OF THE DRAWINGS

Other features and advantages of the disclosure will become apparent in the following detailed description of the embodiment with reference to the accompanying drawings, of which:

FIG. 1 is a fragmentary perspective view of a conventional striker;

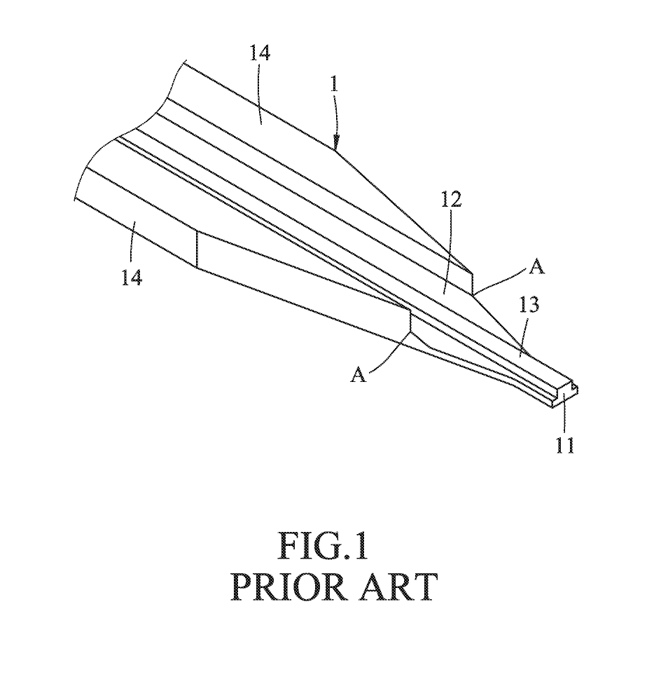

FIG. 2 is a side view of another conventional striker disclosed in Japanese Patent Application Publication No. 2010-69563;

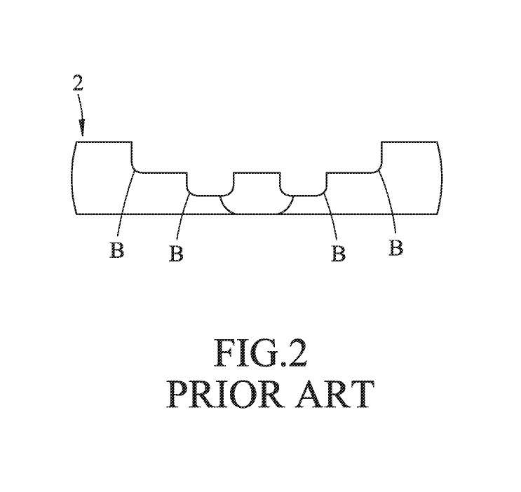

FIG. 3 is a fragmentary side view of still another conventional striker disclosed in U.S. Pat. No. 7,021,516;

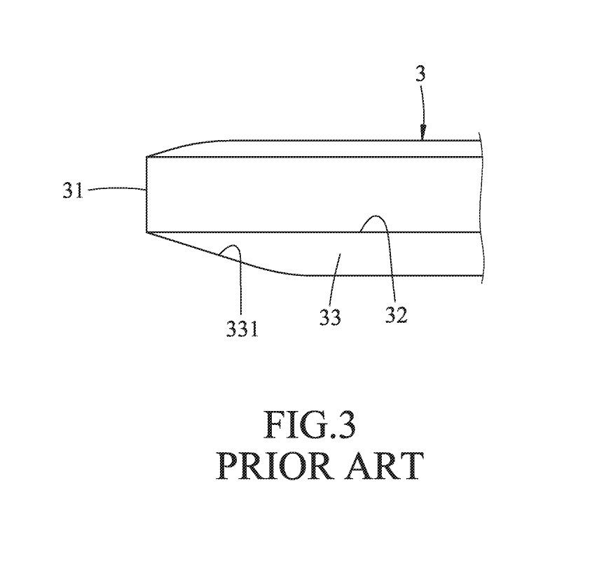

FIG. 4 is a fragmentary perspective view of an embodiment of a striker according to the present disclosure; and

FIG. 5 is a fragmentary side view of the embodiment.

### DETAILED DESCRIPTION

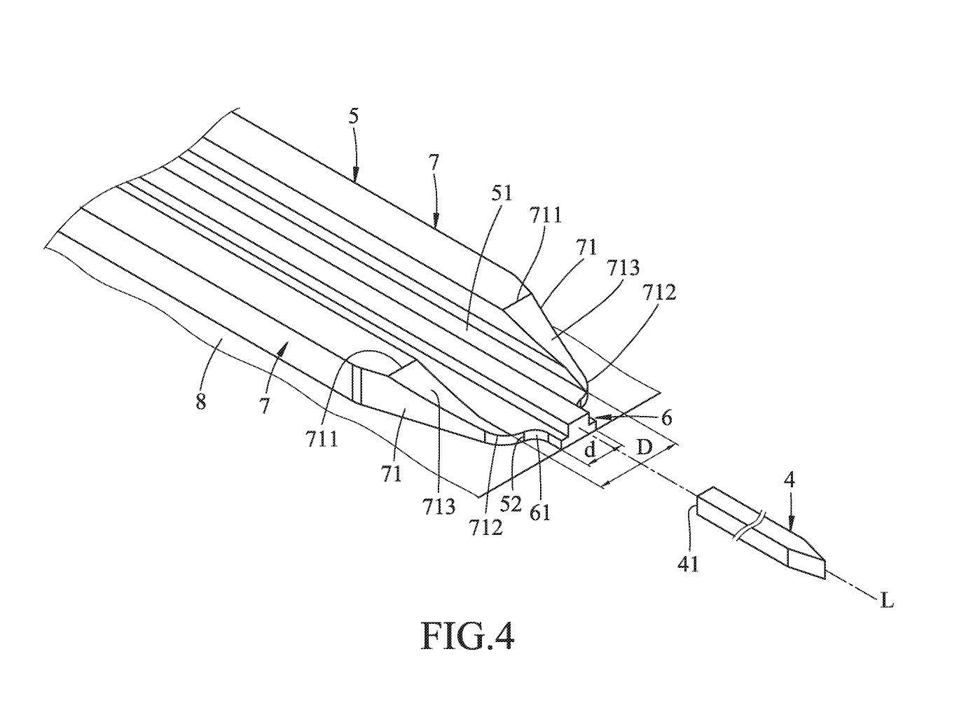

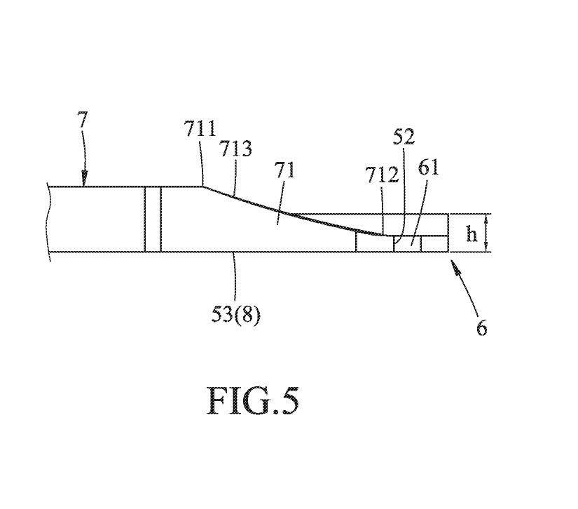

Referring to FIGS. 4 and 5, an embodiment of a striker according to the disclosure is adapted to be slidable along a channel 8 of a nail gun for striking a nail head 41 of a nail 4. The striker includes a base portion 5, a striking portion 6, and two reinforcing ribs 7.

The base portion 5 has a slide surface 53 extending along a longitudinal axis (L) and adapted to be slidable along the channel 8, and a base surface 51 opposite to the sliding surface 53 and extending along the longitudinal axis (L). The base portion 5 further has a front end surface 52 connected between front ends of the slide surface 53 and the base surface 51, and being perpendicular to the longitudinal axis (L).

The striking portion 6 is formed on the front end surface 52 of the base portion 5, and is adapted for striking the nail head 41 of the nail 4. The striking portion 6 has opposite concave surfaces 61 connected to the front end surface 52 of the base portion 5, and has a maximum width (d) in a direction perpendicular to the longitudinal axis (L) that is smaller than a width (D) of the front end surface 52 of the base portion 5. The striking portion 6 includes a rectangular main part and two side parts. The main part extends along the longitudinal axis (L) and has two lateral sides disposed respectively at opposite sides of the longitudinal axis (L). The side parts project respectively from the opposite lateral sides of the main part. Each of the side parts has a respective one of the concave surfaces 61. The main part has a width in a direction perpendicular to the longitudinal axis (L) that ranges from 0.5 millimeter to 1 millimeter, and a height (h) in a direction perpendicular to the width and the longitudinal axis (L) that ranges from 0.5 millimeter to 1 millimeter.

The reinforcing ribs 7 are disposed respectively at the opposite sides of the longitudinal axis (L), are connected to the base portion 5, and extend along the longitudinal axis (L). Each of the reinforcing ribs 7 has an extension portion 71 having an end surface 713 that has first and second edges 711, 712. The first and second edges 711, 712 of each of the reinforcing ribs 7 are disposed respectively distal from and proximate to the base surface 51 in the direction perpendicular to the longitudinal axis (L), and are disposed respectively distal from and proximate to a corresponding one of the curved surface 61 of the striking portion 6 in a direction parallel to the longitudinal axis (L).

In this embodiment, the end surface 713 of each of the reinforcing ribs 7 is an inclined surface, and may be manufactured by stamping process. In other embodiments, the end surface 713 may be concaved toward the base surface 51 of the base portion 5. Since the manufacturing of the end surface 713 is known in the art, further details on the same are omitted herein for the sake of brevity.

The reinforcing ribs 7 enhance the structural strength of the base portion 5. Since the height of the extension portion 71 of each of the reinforcing ribs 7 gradually decreases toward the second edge 712, fracture of the striker due to concentration of stress generated from a nail-striking operation can be effectively prevented.

In comparison with the abovementioned conventional striker 1, the part of the striker according to the present disclosure that bears a significant deformation does not concentrate on the striking portion 6, and the configuration of the extension portion 71 of each of the reinforcing ribs 7 reduces the possibility of fracture of the striker due to concentration of stress.

In addition, unlike the aforesaid conventional striker 3, the end surface 713 of each of the reinforcing ribs 7 is disposed on the base surface 51 and is not disposed in the channel 8, so that the drawback which the nail 4 may be stuck in the channel 8 under the conventional striker 3 can be eliminated.

In the description above, for the purposes of explanation, numerous specific details have been set forth in order to provide a thorough understanding of the embodiment. It will be apparent, however, t one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that his disclosure is not limited to the disclosed embodiment but is intended to cover various arrangements included within the spirit and scope of the broadest interpretation so as to encompass all such modifications and equivalent arrangements.

What is claimed is:

1. A striker adapted to be slidable along a channel of a nail gun for striking a nail head of a nail, said striker comprising:
a base portion having
a slide surface that is adapted to be slidable along the channel,
a base surface that is opposite to said sliding surface, and that extends along a longitudinal axis, and
a front end surface that is connected between said slide surface and said base surface;
a striking portion formed on said front end surface of said base portion, adapted for striking the nail head of the nail, and having a maximum width in a direction perpendicular to the longitudinal axis that is smaller than a width of said front end surface of said base portion; and
two reinforcing ribs disposed respectively at opposite sides of the longitudinal axis, connected to said base portion, and extending along the longitudinal axis, each of said reinforcing ribs having an extension portion that has first and second edges, said first and second edges being disposed respectively distal from and proximate to said base surface in a direction perpendicular to the longitudinal axis, and being disposed respectively distal from and proximate to said striking portion in a direction parallel to the longitudinal axis.

2. The striker as claimed in claim 1, wherein said extension portion of each of said reinforcing ribs further has an end surface that has said first and second edges and that is an inclined surface.

3. The striker as claimed in claim 1, wherein said extension portion of each of said reinforcing ribs further has an end surface that has said first and second edges, and that is concaved toward said base surface of said base portion.

4. The striker as claimed in claim 1, wherein said striking portion has opposite concave surfaces connected to said front end surface of said base portion.

5. The striker as claimed in claim 1, wherein said striking portion has:
a rectangular main part extending along the longitudinal axis, and having two lateral sides that are disposed respectively at opposite sides of the longitudinal axis; and
two side parts projecting respectively from said opposite lateral sides of said main part.

6. The striker as claimed in claim 5, wherein said main part has a width in a direction perpendicular to the longitudinal axis that ranges from 0.5 millimeter to 1 millimeter, and a height in a direction perpendicular to the width and the longitudinal axis that ranges from 0.5 millimeter to 1 millimeter.

7. The striker as claimed in claim 1, wherein said front end surface of said base portion is perpendicular to the longitudinal axis.
